(19) United States
(12) Patent Application Publication
(10) Pub. No.: US 2025/0129221 A1
(43) Pub. Date: Apr. 24, 2025

(54) CADAVERINE-BASED POLYIMIDES

(71) Applicant: Akron Polymer Systems, Inc., Akron, OH (US)

(72) Inventors: Shilpa Naresh Raja, Emeryville, CA (US); Arjan Zoombelt, Emeryville, CA (US); Adam Safir, Berkeley, CA (US); Matthew J. Graham, Akron, OH (US); John D. Harvey, Akron, OH (US)

(73) Assignee: Akron Polymer Systems, Inc., Akron, OH (US)

(21) Appl. No.: 18/695,762

(22) PCT Filed: Sep. 27, 2022
(86) PCT No.: PCT/US2022/077116

§ 371 Date: Mar. 26, 2024

Related U.S. Application Data
(60) Provisional application No. 63/251,506, filed on Oct. 1, 2021.

(51) Int. Cl. C08J 5/18; C08G 73/10

(52) U.S. Cl. CPC C08J 5/18; C08G 73/10; C08J 2379/08

(57) ABSTRACT

The present disclosure relates to polyimides including diaminopentane. In particular examples, the polyimide can be provided as a stretched film.

### STATEMENT OF GOVERNMENT INTEREST

This invention was made with Government support under Contract No. HR0011-15-9-0014 awarded by DARPA. The Government has certain rights in the invention.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in their entireties and for all purposes.

### FIELD OF THE DISCLOSURE

The present disclosure relates generally to polyimides including diaminopentane. In particular examples, the polyimide can be provided as a stretched film.

### BACKGROUND

Conventional polyimides tend to be highly colored materials with diminished optical clarity in the UV-Visible spectrum. Such polyimides also tend to be highly rigid polymers requiring processing at temperatures in excess of 200° C.

### SUMMARY

The present disclosure relates to polyimides including diaminopentane and a dianhydride or a tetracarboxylic acid. In particular instances, such polyimides can be provided as a polymeric article (e.g., a film), which is then stretched at a certain temperature to provide a stretched polymeric article. In non-limiting embodiments, the stretched article exhibits enhanced mechanical properties, in which the stretched article is more flexible than the initial unstretched article.

In a first aspect, the present disclosure encompasses a stretched polymeric article including a polyimide that includes formula (I):

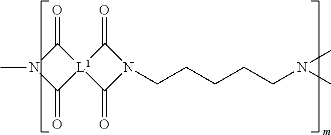

or a salt thereof, wherein: L¹ is a tetravalent organic group; and m is an integer from 1 to 10,000. In some embodiments, the article is characterized by an increased break strain after stretching the article, as compared to an initial break strain before stretching. In other embodiments, the increased break strain is at least about 5, 10, 15, 20, 25, 30, or more times greater than the initial break strain. In yet other embodiments, the article has a break strain of at least about 30%, 50%, 80%, 90%, 100%, 110%, or 120% and/or a break strain from about 70% to about 300%.

In some embodiments, the article is characterized by an increased total strain after stretching the article, as compared to an initial total strain before stretching. In particular embodiments, the increased total strain is at least about 20, 30, 40, 50, 100, or more times greater than the initial total strain. In other embodiments, the article has a total strain of at least about 100%, 130%, 150%, 170%, 180%, 190%, 200%, 500%, or 900% and/or a total strain from about 100% to about 1000%.

In a second aspect, the present disclosure features a heat-stretched polymeric article including a polyimide that includes formula (I):

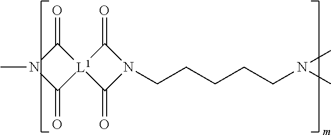

or a salt thereof, wherein: L¹ is a tetravalent organic group; and m is an integer from 1 to 10,000. In some embodiments, the article is characterized by a break strain greater than about 30%, 50%, 80%, 100%, 120%, or more and/or a break strain from about 70% to about 300%. In other embodiments, the article is characterized by a total strain of about 100%, 120%, 150%, 200%, 500%, 900%, or more and/or a total strain from about 100% to about 1000%.

In some embodiments, the heat-stretched polymeric article is heat stretched at a temperature within about ±50%, ±40%, ±30%, or ±20% of a glass transition temperature (T_{g}) of the polyimide.

In some embodiments, the polyimide and/or the article includes one or more of the following properties:
a. an in-plane retardation at wavelength of 550 nm (Re550) is about 5 nm, 10 nm, 15 nm, 20 nm, 25 nm, 30 nm, or more or from about 1 nm to about 100 nm;
b. a ratio of in-plane retardation at wavelengths of 450 nm and 550 nm (Re450/Re550) is about 1.2, 1.1, 1.0, or less;
c. a ratio of in-plane retardation at wavelengths of 650 nm and 550 nm (Re650/Re550) is about 0.9, 0.95, 0.99, 1.0, or more;
d. a retardation in a thickness direction at wavelength of 550 nm (Rth550) is about −0.5 nm, −10 nm, −15 nm, −20 nm, −25 nm, −30 nm, or less;
e. a ratio of retardation in a thickness direction at wavelengths of 450 nm and 550 nm (Rth450/Rth550) is about 0.9, 0.95, 0.97, 0.98, or more;
f. a ratio of retardation in a thickness direction at wavelengths of 650 nm and 550 nm (Rth650/Rth550) is about 1.3, 1.2, 1.1, 1.0, 0.99, or less;
g. a glass transition temperature (Tg) is more than about 95° C. or from about 100° C. to about 400° C. (ASTM D3418-15, D4065, D4440, or D5279);
h. a Young's modulus of from about 0.5 GPa to about 10 GPa (ASTM D638 or ISO 527-1/-2);
i. a yield stress of from about 10 MPa to about 100 MPa, such as from about 10 MPa to 80 MPa (ASTM D638 or ISO 527-1/-2);
j. a break strain of from about 7% to about 300% (ASTM D638 or ISO 527-1/-2);
k. a total strain of from about 7% to about 1200% (ASTM D638 or ISO 527-1/-2);
l. a break stress of from about 40 MPa to about 250 MPa (ASTM D638 or ISO 527-1/-2);
m. a dielectric constant of from about 2.8 to about 4.0 at 1 MHz (IPC-TM-650/2.5.5.3);
n. a dielectric dissipation factor of from about 0.001 to about 0.03 at 1 MHz (IPC-TM-650/2.5.5.3);
o. a flame retardance classification of UL-94 HB;
p. an optical transmittance of at least about 60% at 400 nm and above, such as at least about 60%, 70%, 80%, or 90%; and/or
q. a yellowness index of not greater than about 2.5, such as not greater than about 2.6 (ASTM E313-15e1).

In some embodiments, the polyimide (e.g., having formula (I)) includes L¹ having one or more cyclic aliphatic groups (e.g., cyclic saturated or unsaturated carbon-containing groups). In particular embodiments, the cyclic aliphatic group includes one or more optionally substituted trivalent or tetravalent cycloalkylene groups. In other embodiments, two or more cycloalkylene groups are attached to each other by one or more linkers (e.g., a linker being L², which can be any described herein, such as a covalent bond, oxy, an optionally substituted alkylene, an optionally substituted heteroalkylene, an ester bond, carbonyl, thio, sulfonyl, imino, or an amide bond). Optionally substituents for cycloalkylene include any described herein for alkyl.

In some embodiments, the polyimide includes formula (Ia) or formula (1), as described herein. In other embodiments, the article or the polyimide further includes one or more additives.

In some embodiments, the article is configured for use in consumer electronics, complex electronics, packaging, health care products, computers, or automotive applications. In other embodiments, the article includes an electronic, aerospace, automotive, architectural, industrial, or civil engineering application.

In some embodiments, the article includes a flexible circuit, a flexible component, a flexible connector, a flexible substrate, a flexible coating, a flexible sensor, a conformal coating, a conformal substrate, a wearable electronic device, a conformal component, a soft electronic component, or a conformal antenna. In particular embodiments, the article is formed from a polyimide (e.g., any described herein).

In some embodiments, the article includes a flexible electronic component (e.g., a flexible circuit, a flexible component, a flexible connector, a flexible substrate, a flexible coating, and/or a flexible sensor) configured to be heat treated, soldered, or welded.

In some embodiments, the article includes a tubing, a film, a substrate, a fiber, a coating, a sheet, a molded article, a housing, a connector, a frame, or an extruded article. In particular embodiments, the article is a film or a substrate with a thickness between 10 nanometers and 1 cm. In other embodiments, the article is coated with a polyimide (e.g., any described herein).

In a third aspect, the present disclosure encompasses a method of making a polymeric article, the method including: combining 1,5-diaminopentane and an aliphatic dianhydride or tetracarboxylic acid thereof, thereby providing a polyimide. In some embodiments, the method further includes (e.g., after said combining): forming the polymeric article including the polyimide. In other embodiments, the method further includes (e.g., after said forming): stretching the polyimide in the presence of heat to provide a heat-stretched polymeric article.

In some embodiments, the article is characterized by: an increased break strain after stretching the article, as compared to an initial break strain before stretching; and/or a break strain greater than about 30%, 50%, 80%, 100%, 120%, or more.

In some embodiments, the aliphatic dianhydride or tetracarboxylic acid thereof is 3,3′,4,4′-bicyclohexyltetracarboxylic acid dianhydride (HBPDA), 2,2′,3,3′-bicyclohexyltetracarboxylic dianhydride (3,3′-HBPDA), 2,3′,3,4′-bicyclohexyltetracarboxylic dianhydride (3,4′-HBPDA), or a stereoisomer thereof.

In other embodiments, the aliphatic dianhydride or tetracarboxylic acid thereof is or includes formula (II) or (III):

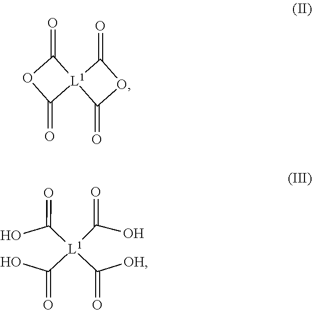

or a salt thereof, wherein L¹ is a tetravalent organic group (e.g., any described herein). In some embodiments, L¹ includes one or more cyclic aliphatic groups (e.g., cyclic saturated or unsaturated carbon-containing groups), such as any described herein. In some embodiments, the polyimide includes the formula (I), (Ia), or (1), as described herein.

In some embodiments, said combining includes providing 1,5-diaminopentane and the aliphatic dianhydride or tetracarboxylic acid thereof at a molar ratio of about 1:1 (e.g., a molar ratio of about 1:1 of 1,5-diaminopentane to an aliphatic dianhydride; or a molar ratio of about 1:1 of 1,5-diaminopentane to a tetracarboxylic acid of the aliphatic dianhydride).

In particular embodiments, said forming provides the polymeric article. In some embodiments, the polyimide includes a tubing, a film, a substrate, a fiber, a coating, a sheet, a molded article, a housing, a connector, a frame, or an extruded article.

In some embodiments, said stretching includes a temperature within about ±50%, ±40%, ±30%, ±25%, or ±20% of a T_{g} of the polyimide. In other embodiments, said stretching includes a temperature more than about 90° C., 95° C., 100° C., 110° C., or 120° C. In yet other embodiments, said stretching includes a temperature of from about 100° C. to about 400° C., such as from about 100° C. to 200° C., 100° C. to 250° C., 100° C. to 300° C., 100° C. to 350° C., 110° C. to 200° C., 110° C. to 250° C., 110° C. to 300° C., 110° C. to 350° C., 110° C. to 400° C., 120° C. to 200° C., 120° C. to 250° C., 120° C. to 300° C., 120° C. to 350° C., 120° C. to 400° C., 130° C. to 200° C., 130° C. to 250° C., 130° C. to 300° C., 130° C. to 350° C., 130° C. to 400° C., 140° C. to 200° C., 140° C. to 250° C., 140° C. to 300° C., 140° C. to 350° C., or 140° C. to 400° C. In particular embodiments, said stretching includes uniaxial stretching (e.g., a stretch ratio of about 1.2 by 1 to 4 by 1) or biaxial stretching (e.g., a stretch ratio of about 1.1 by 1.1 to 4 by 4 or about 1.1 by 2.1 to 2.5 by 4). Such biaxial stretching can include symmetric biaxial stretching, in which an equal amount of stretching is applied in both longitudinal and transverse directions; as well as asymmetric biaxial stretching, in which a different amount of stretching is applied in both longitudinal and transverse directions. In yet other embodiments, said stretching includes stretching in an amount of 1.1 to 4 in at least one direction (e.g., in a longitudinal or transverse direction, in which stretching amount is determined as a ratio of the final dimension of the film after stretching to the initial dimension of the film before stretching).

In any embodiment herein, the article (e.g., the stretched polymeric article or the heat-stretched polymeric article) has a break strain of at least about 30%, at least about 50%, at least about 80%, at least about 90%, at least about 100%, at least about 110%, or at least about 120%.

In any embodiment herein, the article (e.g., the stretched polymeric article or the heat-stretched polymeric article) has a break strain from about 70% to about 300% (e.g., from 70% to 150%, 70% to 200%, 70% to 250%, 80% to 150%, 80% to 200%, 80% to 250%, 80% to 300%, 90% to 150%, 90% to 200%, 90% to 250%, 90% to 300%, 100% to 150%, 100% to 200%, 100% to 250%, 100% to 300%, 110% to 150%, 110% to 200%, 110% to 250%, 110% to 300%, 120% to 150%, 120% to 200%, 120% to 250%, or 120% to 300%).

In any embodiment herein, the article (e.g., the stretched polymeric article or the heat-stretched polymeric article) has a total strain of at least about 100%, at least about 130%, at least about 150%, at least about 170%, at least about 180%, at least about 190%, at least about 200%, at least about 500%, or at least about 900%.

In any embodiment herein, the article (e.g., the stretched polymeric article or the heat-stretched polymeric article) has a total strain from about 100% to about 1000% (from 100% to 300%, 100% to 500%, 100% to 800%, 100% to 900%, 100% to 950%, 200% to 300%, 200% to 500%, 200% to 800%, 200% to 900%, 200% to 950%, or 200% to 1000%).

In any embodiment herein, the polyimide and/or the article (e.g., the stretched polymeric article or the heat-stretched polymeric article) includes one or more of the following properties:
a. an Re550 is about 5 nm or more;
b. an Re450/Re550 is about 1.2 or less;
c. an Re650/Re550 is about 0.9 or more;
d. an Rth550 is about −0.5 nm or less;
e. an Rth450/Rth550 is about 0.9 or more;
f. an Rth650/Rth550 is about 1.3 or less;
g. a Tg of about 100° C. or more (ASTM D3418-15, D4065, D4440, or D5279);
h. a Young's modulus of about 0.5 GPa or more (ASTM D638 or ISO 527-1/-2);
i. a yield stress of about 10 MPa or more (ASTM D638 or ISO 527-1/-2);
j. a break strain of about 7% or more (ASTM D638 or ISO 527-1/-2);
k. a total strain of about 7% or more (ASTM D638 or ISO 527-1/-2);
l. a break stress of about 80 MPa or more (ASTM D638 or ISO 527-1/-2);
m. a dielectric constant of about 2.8 or more at 1 MHz (IPC-TM-650/2.5.5.3);
n. a dielectric dissipation factor of about 0.001 or more at 1 MHz (IPC-TM-650/2.5.5.3);
o. a flame retardance classification of UL-94 HB;
p. an optical transmittance of at least about 60% at 400 nm and above;
and/or
q. a yellowness index of not greater than about 2.5 (ASTM E313-15e1).

In any embodiment herein, a polyimide includes or is the formula (I):

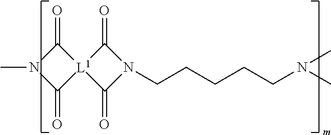

or a salt thereof, wherein: L¹ is a tetravalent organic group; and m is an integer from 1 to 10,000. In some embodiments, L¹ includes one or more cyclic aliphatic groups (e.g., cyclic saturated or unsaturated carbon-containing groups). In particular embodiments, the cyclic aliphatic group includes one or more optionally substituted trivalent or tetravalent cycloalkylene groups. In other embodiments, the two or more cycloalkylene groups are attached to each other by one or more linkers (e.g., a linker being L², which can be any described herein, such as a covalent bond, oxy, an optionally substituted alkylene, an optionally substituted heteroalkylene, an ester bond, carbonyl, thio, sulfonyl, imino, or an amide bond). Optionally substituents for cycloalkylene include any described herein for alkyl.

In any embodiment herein, a polyimide includes or is the formula (Ia):

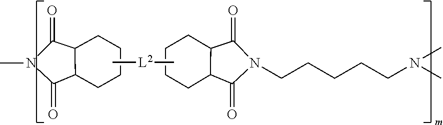

or a salt thereof, wherein: L² is a covalent bond, oxy, an optionally substituted alkylene, or an optionally substituted heteroalkylene.

In any embodiment herein, a polyimide includes or is the formula (1):

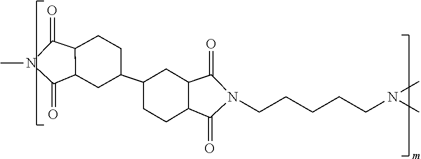

or a salt thereof.

In any embodiment herein, the article is configured for use in consumer electronics, complex electronics, packaging, health care products, computers, or automotive applications. In other embodiments, the article includes a flexible circuit, a flexible component, a flexible connector, a flexible substrate, a flexible coating, a flexible sensor, a conformal coating, a conformal substrate, a wearable electronic device, a conformal component, a soft electronic component, or a conformal antenna. In yet other embodiments, the article includes a flexible electronic component configured to be heat treated, soldered, or welded. In some embodiments, the article includes a tubing, a film, a substrate, a fiber, a coating, a sheet, a molded article, a housing, a connector, a frame, or an extruded article.

In any embodiment herein, the article includes an electronic, aerospace, automotive, architectural, industrial, or civil engineering application.

In any embodiment herein, the article is the film or the substrate with a thickness between 10 nanometers and 1 cm.

In any embodiment herein, the article is coated with a polyimide (e.g., any described herein). In other embodiments, the article is composed of a polyimide (e.g., any described herein).

Additional details follow.

### Definitions

By “alkyl” and the prefix “alk” is meant a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can be substituted with one, two, three or, in the case of alkyl groups of two carbons or more, four substituents independently selected from the group consisting of: (1) C₁₋₆ alkoxy (e.g., —O-Ak, wherein Ak is optionally substituted C₁₋₆ alkyl); (2) C₁₋₆ alkylsulfinyl (e.g., —S(O)-Ak, wherein Ak is optionally substituted C₁₋₆ alkyl); (3) C₁₋₆ alkylsulfonyl (e.g., —SO₂-Ak, wherein Ak is optionally substituted C₁₋₆ alkyl); (4) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (5) aryl; (6) arylalkoxy (e.g., —O-L-Ar, wherein L is a bivalent form of optionally substituted alkyl and Ar is optionally substituted aryl); (7) aryloyl (e.g., —C(O)—Ar, wherein Ar is optionally substituted aryl); (8) azido (e.g., —N═N—); (9) cyano (e.g., —CN); (10) carboxyaldehyde (e.g., —C(O)H); (11) C₃₋₈ cycloalkyl (e.g., a monovalent saturated or unsaturated non-aromatic cyclic C₃₋₈ hydrocarbon group); (12) halo (e.g., F, Cl, Br, or I); (13) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (14) heterocyclyloxy (e.g., —O-Het, wherein Het is heterocyclyl, as described herein); (15) heterocyclyloyl (e.g., —C(O)—Het, wherein Het is heterocyclyl, as described herein); (16) hydroxyl (e.g., —OH); (17) N-protected amino; (18) nitro (e.g., —NO₂); (19) oxo (e.g., ═O); (20) C₃₋₈ spirocyclyl (e.g., an alkylene or heteroalkylene diradical, both ends of which are bonded to the same carbon atom of the parent group); (21) C₁₋₆ thioalkoxy (e.g., —S-Ak, wherein Ak is optionally substituted C₁₋₆ alkyl); (22) thiol (e.g., —SH); (23) —CO₂R^{A}, where R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (24) —C(O)NR^{B}R^{C}, where each of R^{B} and R^{C} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (25) —SO₂R^{D}, where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl group and Ar is optionally substituted aryl); (26) —SO₂NR^{E}R^{F}, where each of RE and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); and (27) —NR^{G}R^{H}, where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., L-Ar, wherein L is a bivalent form of optionally substituted alkyl group and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl group and Cy is optionally substituted cycloalkyl, as described herein), wherein in one embodiment no two groups are bound to the nitrogen atom through a carbonyl group or a sulfonyl group. The alkyl group can be a primary, secondary, or tertiary alkyl group substituted with one or more substituents (e.g., one or more halo or alkoxy). In some embodiments, the unsubstituted alkyl group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, C₂₋₂₄, C₃₋₆, C₃₋₁₂, C₃₋₁₆, C₃₋₁₈, C₃₋₂₀, C₃₋₂₄, C₄₋₆, C₄₋₁₂, C₄₋₁₆, C₄₋₁₈, C₄₋₂₀, C₄₋₂₄, C₅₋₆, C₅₋₁₂, C₅₋₁₆, C₅₋₁₈, C₅₋₂₀, C₅₋₂₄, C₆₋₁₂, C₆₋₁₆, C₆₋₁₈, C₆₋₂₀, C₆₋₂₄, C₇₋₁₂, C₇₋₁₆, C₇₋₁₈, C₇₋₂₀, C₇₋₂₄, C₈₋₁₂, C₈₋₁₆, C₈₋₁₈, C₈₋₂₀, C₈₋₂₄, C₉₋₁₂, C₉₋₁₆, C₉₋₁₈, C₉₋₂₀, C₉₋₂₄, C₁₀₋₁₂, C₁₀₋₁₆, C₁₀₋₁₈, C₁₀₋₂₀, or C₁₋₂₄ alkyl group.

By “alkylene” is meant a multivalent (e.g., bivalent, trivalent, tetravalent, etc.) form of an alkyl group, as described herein. Non-limiting alkylene groups include methylene, ethylene, propylene, butylene, etc. In some embodiments, the alkylene group is a C₁₋₃, C₁₋₆, C₁₋₁₂, C₁₋₁₆, C₁₋₁₈, C₁₋₂₀, C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can also be substituted or unsubstituted. For example, the alkylene group can be substituted with one or more substitution groups, as described herein for alkyl.

By “amide bond” is meant —C(O)NR^{N1}— or —NR^{N1}C(O)—, where R^{N1} is H or optionally substituted alkyl. A non-limiting amide bond includes —C(O)NH—.

By “aryl” is meant a group that contains any carbon-based aromatic group including, but not limited to, phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted or unsubstituted. The aryl group can be substituted with one, two, three, four, or five substituents independently selected from the group consisting of: (1) C₁₋₆ alkanoyl (e.g., —C(O)-Ak, wherein Ak is optionally substituted C₁₋₆ alkyl); (2) C₁₋₆ alkyl; (3) C₁₋₆ alkoxy (e.g., —O-Ak, wherein Ak is optionally substituted C₁₋₆ alkyl); (4) C₁₋₆ alkoxy-C₁₋₆ alkyl (e.g., -L-O-Ak, wherein L is a bivalent form of optionally substituted alkyl group and Ak is optionally substituted C₁₋₆ alkyl); (5) C₁₋₆ alkylsulfinyl (e.g., —S(O)-Ak, wherein Ak is optionally substituted C₁₋₆ alkyl); (6) C₁₋₆ alkylsulfinyl-C₁₋₆ alkyl (e.g., -L-S(O)-Ak, wherein L is a bivalent form of optionally substituted alkyl group and Ak is optionally substituted C₁₋₆ alkyl); (7) C₁₋₆ alkylsulfonyl (e.g., —SO₂-Ak, wherein Ak is optionally substituted C₁₋₆ alkyl); (8) C₁₋₆ alkylsulfonyl-C₁₋₆ alkyl (e.g., -L-SO₂-Ak, wherein L is a bivalent form of optionally substituted alkyl group and Ak is optionally substituted C₁₋₆ alkyl); (9) aryl; (10) amino (e.g., —NR^{N1}R^{N2} where each of R^{N1} and R^{N2} is, independently, H or optionally substituted alkyl, or R^{N1} and R^{N2}, taken together with the nitrogen atom to which each are attached, form a heterocyclyl group); (11) C₁₋₆ aminoalkyl (e.g., an alkyl group, as defined herein, substituted by one or more —NR^{N1}R^{N2} groups, as described herein); (12) heteroaryl (e.g., a subset of heterocyclyl groups (e.g., a 5-, 6- or 7-membered ring, unless otherwise specified, containing one, two, three, or four non-carbon heteroatoms), which are aromatic); (13) (C₄₋₁₈ aryl) C₁₋₆ alkyl (e.g., -L-Ar, wherein L is a bivalent form of optionally substituted alkyl and Ar is optionally substituted aryl); (14) aryloyl (e.g., —C(O)—Ar, wherein Ar is optionally substituted aryl); (15) azido (e.g., —N₃); (16) cyano (e.g., —CN); (17) C₁₋₆ azidoalkyl (e.g., an alkyl group, as defined herein, substituted by one or more azido groups, as described herein); (18) carboxyaldehyde (e.g., —C(O)H); (19) carboxyaldehyde-C₁₋₆ alkyl (e.g., an alkyl group, as defined herein, substituted by one or more carboxyaldehyde groups, as described herein); (20) C₃₋₈ cycloalkyl (e.g., a monovalent saturated or unsaturated non-aromatic cyclic C₃₋₈ hydrocarbon group); (21) (C₃₋₈ cycloalkyl) C₁₋₆ alkyl (e.g., an alkyl group, as defined herein, substituted by one or more cycloalkyl groups, as described herein); (22) halo (e.g., F, Cl, Br, or I); (23) C₁₋₆ haloalkyl (e.g., an alkyl group, as defined herein, substituted by one or more halo groups, as described herein); (24) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (25) heterocyclyloxy (e.g., —O-Het, wherein Het is heterocyclyl, as described herein); (26) heterocyclyloyl (e.g., —C(O)—Het, wherein Het is heterocyclyl, as described herein); (27) hydroxyl (e.g., —OH); (28) C₁₋₆ hydroxyalkyl (e.g., an alkyl group, as defined herein, substituted by one or more hydroxyl, as described herein); (29) nitro (e.g., —NO₂); (30) C₁₋₆ nitroalkyl (e.g., an alkyl group, as defined herein, substituted by one or more nitro, as described herein); (31) N-protected amino; (32) N-protected amino-C₁₋₆ alkyl (e.g., an alkyl group, as defined herein, substituted by one or more N-protected amino groups); (33) oxo (e.g., ═O); (34) C₁₋₆ thioalkoxy (e.g., —S-Ak, wherein Ak is optionally substituted C₁₋₆ alkyl); (35) thio-C₁₋₆ alkoxy-C₁₋₆ alkyl (e.g., -L-S-Ak, wherein L is a bivalent form of optionally substituted alkyl and Ak is optionally substituted C₁₋₆ alkyl); (36) —(CH₂)ᵣCO₂R^{A}, where r is an integer of from zero to four, and R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (37) —(CH₂)ᵣCONR^{B}R^{C}, where r is an integer of from zero to four and where each R^{B} and R^{C} is independently selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (38) —(CH₂)ᵣSO₂R^{D}, where r is an integer of from zero to four and where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl and Ar is optionally substituted aryl); (39) —(CH₂)ᵣSO₂NR^{E}R^{F}, where r is an integer of from zero to four and where each of RE and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (40) —(CH₂)ᵣNR^{G}R^{H}, where r is an integer of from zero to four and where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., -L-Ar, wherein L is a bivalent form of optionally substituted alkyl and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl and Cy is optionally substituted cycloalkyl, as described herein), wherein in one embodiment no two groups are bound to the nitrogen atom through a carbonyl group or a sulfonyl group; (41) thiol (e.g., —SH); (42) perfluoroalkyl (e.g., an alkyl group having each hydrogen atom substituted with a fluorine atom); (43) perfluoroalkoxy (e.g., —OR^{f}, where R^{f} is an alkyl group having each hydrogen atom substituted with a fluorine atom); (44) aryloxy (e.g., —OAr, where Ar is optionally substituted aryl); (45) cycloalkoxy (e.g., —O-Cy, wherein Cy is optionally substituted cycloalkyl, as described herein); (46) cycloalkylalkoxy (e.g., —O-L-Cy, wherein L is a bivalent form of optionally substituted alkyl and Cy is optionally substituted cycloalkyl, as described herein); and (47) arylalkoxy (e.g., —O-L-Ar, wherein L is a bivalent form of optionally substituted alkyl and Ar is optionally substituted aryl). In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group.

By “arylene” is meant a multivalent (e.g., bivalent, trivalent, tetravalent, etc.) form of an aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for aryl.

By “carbonyl” is meant a —C(O)— group, which can also be represented as >C═O.

By “cycloalkyl” is meant a monovalent saturated or unsaturated non-aromatic cyclic hydrocarbon group of from three to ten carbons (e.g., C₃₋₈ or C₃₋₁₀), unless otherwise specified, and is exemplified by cyclopropyl, cyclobutyl, cyclopentyl, cyclohexyl, cycloheptyl, bicyclo[2.2.1.]heptyl, and the like. The term cycloalkyl also includes “cycloalkenyl,” which is defined as a non-aromatic carbon-based ring composed of three to ten carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The cycloalkyl group can also be substituted or unsubstituted. For example, the cycloalkyl group can be substituted with one or more groups including those described herein for alkyl.

By “cycloalkylene” is meant a multivalent (e.g., bivalent, trivalent, tetravalent, etc.) form of a cycloalkyl group, as described herein. Exemplary cycloalkylene groups include cyclopropylene, cyclobutylene, cyclopentylene, cyclohexylene, cyclohexenylene, cyclohexadienylene, etc. In some embodiments, the cycloalkylene group is a C₃₋₆, C₃₋₁₂, C₃₋₁₆, C₃₋₁₈, C₃₋₂₀, or C₃₋₂₄ cycloalkylene group. The cycloalkylene group can be branched or unbranched. The cycloalkylene group can also be substituted or unsubstituted. For example, the cycloalkylene group can be substituted with one or more substitution groups, as described herein for alkyl.

By “ester bond” is meant is meant —C(O)O— or —OC(O)—.

By “halo” is meant F, Cl, Br, or I.

By “haloalkyl” is meant an alkyl group, as defined herein, substituted with one or more halo.

By “heteroalkylene” is meant a multivalent (e.g., bivalent, trivalent, tetravalent, etc.) form of an alkylene group, as defined herein, containing one, two, three, or four non-carbon heteroatoms (e.g., independently selected from the group consisting of nitrogen, oxygen, phosphorous, sulfur, selenium, or halo). The heteroalkylene group can be substituted or unsubstituted. For example, the heteroalkylene group can be substituted with one or more substitution groups, as described herein for alkyl.

By “imino” is meant —NR^{L1}—, where R^{L1} is H, optionally substituted alkyl, or optionally substituted aryl.

By “oxy” is meant —O—.

By “sulfonyl” is meant an —S(O)₂— group.

By “thio” is meant an —S— group.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S M et al., “Pharmaceutical salts,” J. Pharm. Sci. 1977 January; 66(1):1-19; and in “Handbook of Pharmaceutical Salts: Properties, Selection, and Use,” Wiley-VCH, April 2011 (2nd rev. ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium).

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

As used herein, the term “about” means+/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

### BRIEF DESCRIPTION OF THE DRAWINGS

FIG. 1A-1B shows photographs of a polyimide film (A) before stretching and (B) after stretching, which shows a uniaxial stretched film with constraint (stretch ratio of 3.0×1.0) at a stretch temperature of 140° C. and stretch rate of 1%/s.

FIG. 2A-2B shows stress-strain curves for a polyimide film after stretching. Provided are graphs for (A) a uniaxial stretched film with constraint (stretch ratio of 3.0×1.0) at a stretch temperature of 140° C. and stretch rate of 1%/s and (B) a uniaxial stretched film with constraint (stretch ratio of 3.0×1.0) at a stretch temperature of 130° C. and stretch rate of 1%/s.

### DETAILED DESCRIPTION

The present disclosure relates to a stretched polymeric article, which can optionally be stretched in the presence of heat to provide a heat-stretched polymeric article. In particular embodiments, the article is heat stretched at a temperature within about 50% of a glass transition temperature (T_{g}) of the polyimide. Such an article can be characterized by an increased break strain after stretching the article, as compared to an initial break strain before stretching; or by an increased total strain after stretching, as compared to an initial total strain before stretching. In this way, the stretched article exhibits beneficial mechanical properties.

In non-limiting embodiments, the stretched article retains beneficial optical, electrical, and flammability properties (e.g., any described herein). Non-limiting mechanical, optical, and other chemical properties and methods of determining such properties are described in U.S. Pat. No. 8,368,859 and Int. Pub. Nos. WO 2019/156717 and WO 2020/068276, each of which is incorporated herein by reference in its entirety.

Yet other characteristics include any of the following:
a. an Re550 is 5 nm, 10 nm, 15 nm, 20 nm, 25 nm, 30 nm, or more, or from 1 nm to 100 nm (e.g., 1 nm to 60 nm, 1 nm to 80 nm, 2 nm to 60 nm, 2 nm to 80 nm, 2 nm to 100 nm, 5 nm to 60 nm, 5 nm to 80 nm, or 5 nm to 100 nm);
b. an Re450/Re550 is 1.2, 1.1, 1.0, or less, or from 0.9 to 1.2 (e.g., 0.9 to 1.1, 0.9 to 1.0, 0.9 to 0.99, 0.95 to 1.1, 0.95 to 1.0, or 0.95 to 0.99);
c. an Re650/Re550 is 0.9, 0.95, 0.99, 1.0, or more, or from 0.9 to 1.1 (e.g., 0.9 to 0.99, 0.9 to 1.0, 0.95 to 0.99, 0.95 to 1.0, or 0.95 to 1.1);
d. an Rth550 is −0.5 nm, −10 nm, −15 nm, −20 nm, −25 nm, −30 nm, or less, or from −0.5 nm to −80 nm (e.g., from −0.5 nm to −50 nm, −0.5 nm to −60 nm, −1 nm to −50 nm, −1 nm to −60 nm, −1 nm to −80 nm, −5 nm to −50 nm, −5 nm to −60 nm, −5 nm to −80 nm, −10 nm to −50 nm, −10 nm to −60 nm, −10 nm to −80 nm, −15 nm to −50 nm, −15 nm to −60 nm, or −15 nm to −80 nm);
e. an Rth450/Rth550 is 0.9, 0.95, 0.97, 0.98, or more or from 0.9 to 1.2 (e.g., from 0.9 to 1.0, 0.9 to 1.1, 0.93 to 1.0, 0.93 to 1.1, 0.93 to 1.2, 0.95 to 1.0, 0.95 to 1.1, 0.95 to 1.2, 0.99 to 1.0, 0.99 to 1.1, or 0.99 to 1.2);
f. an Rth650/Rth550 is 1.3, 1.2, 1.1, 1.0, 0.99, or less or from 0.9 to 1.3 (e.g., from 0.9 to 1.2, 0.9 to 1.1, 0.9 to 1.0, 0.95 to 1.3, 0.95 to 1.2, 0.95 to 1.1, 0.95 to 1.0, 0.97 to 1.3, 0.97 to 1.2, 0.97 to 1.1, 0.97 to 1.0, 0.98 to 1.3, 0.98 to 1.2, 0.98 to 1.1, or 0.98 to 1.0);
g. a Tg of more than 95° C., 100° C., 125° C., 150° C., 175° C., 200° C., 225° C., 250° C., or 275° C.; or from 100° C. to 400° C. (e.g., 100° C. to 200° C., 100° C. to 220° C., 100° C. to 250° C., 100° C. to 300° C., 100° C. to 350° C., 120° C. to 200° C., 120° C. to 220° C., 120° C. to 250° C., 120° C. to 300° C., 120° C. to 350° C., 120° C. to 400° C., 130° C. to 200° C., 130° C. to 220° C., 130° C. to 250° C., 130° C. to 300° C., 130° C. to 350° C., 130° C. to 400° C., 140° C. to 200° C., 140° C. to 220° C., 140° C. to 250° C., 140° C. to 300° C., 140° C. to 350° C., 140° C. to 400° C., 145° C. to 200° C., 145° C. to 220° C., 145° C. to 250° C., 145° C. to 300° C., 145° C. to 350° C., or 145° C. to 400° C.) (ASTM D3418-15, D4065, D4440, or D5279), which can be determined by differential scanning calorimetry (DSC) or by dynamic mechanical analysis (DMA);
h. a Young's modulus of from 0.5 GPa to 10 GPa (e.g., from 0.5 GPa to 3 GPa, 0.5 GPa to 5 GPa, 0.8 GPa to 3 GPa, 0.8 GPa to 5 GPa, 0.8 GPa to 10 GPa, 1 GPa to 3 GPa, 1 GPa to 5 GPa, 1 GPa to 10 GPa, 2 GPa to 3 GPa, 2 GPa to 5 GPa, or 2 GPa to 10 GPa) (ASTM D638 or ISO 527-1/-2);
i. a yield stress of from 10 MPa to 100 MPa (e.g., from 10 MPa to 80 MPa, 10 MPa to 90 MPa, 10 MPa to 95 MPa, 30 MPa to 80 MPa, 30 MPa to 90 MPa, 30 MPa to 95 MPa, 30 MPa to 100 MPa, 40 MPa to 80 MPa, 40 MPa to 90 MPa, 40 MPa to 95 MPa, or 40 MPa to 100 MPa) (ASTM D638 or ISO 527-1/-2);
j. a break strain of from 7% to 300% (e.g., from 7% to 200%, 7% to 250%, 10% to 200%, 10% to 250%, 10% to 300%, 20% to 200%, 20% to 250%, 20% to 300%, 25% to 200%, 25% to 250%, 25% to 300%, 30% to 200%, 30% to 250%, or 30% to 300%) (ASTM D638 or ISO 527-1/-2);
k. a total strain of from 7% to 1200% (e.g., from 7% to 950%, 7% to 1000%, 7% to 1100%, 10% to 950%, 10% to 1000%, 10% to 1100%, 10% to 1200%, 25% to 950%, 25% to 1000%, 25% to 1100%, 25% to 1200%, 50% to 950%, 50% to 1000%, 50% to 1100%, 50% to 1200%, 75% to 950%, 75% to 1000%, 75% to 1100%, 75% to 1200%, 100% to 950%, 100% to 1000%, 100% to 1100%, 100% to 1200%, 150% to 950%, 150% to 1000%, 150% to 1100%, 150% to 1200%, 200% to 950%, 200% to 1000%, 200% to 1100%, 200% to 1200%, 250% to 950%, 250% to 1000%, 250% to 1100%, 250% to 1200%, 300% to 950%, 300% to 1000%, 300% to 1100%, or 300% to 1200%) (ASTM D638 or ISO 527-1/-2);
l. a break stress of from 40 MPa to 250 MPa (e.g., from 40 MPa to 100 MPa, 40 MPa to 150 MPa, 40 MPa to 200 MPa, 50 MPa to 100 MPa, 50 MPa to 150 MPa, 50 MPa to 200 MPa, 50 MPa to 250 MPa, 60 MPa to 100 MPa, 60 MPa to 150 MPa, 60 MPa to 200 MPa, 60 MPa to 250 MPa, 70 MPa to 100 MPa, 70 MPa to 150 MPa, 70 MPa to 200 MPa, 70 MPa to 250 MPa, 80 MPa to 100 MPa, 80 MPa to 150 MPa, 80 MPa to 200 MPa, or 80 MPa to 250 MPa) (ASTM D638 or ISO 527-1/-2);
m. a dielectric constant of from 2.8 to 4.0 at 1 MHz (e.g., from 2.8 to 3.0, 2.8 to 3.2, 2.8 to 3.4, 2.8 to 3.6, 2.8 to 3.8, 3.0 to 3.2, 3.0 to 3.4, 3.0 to 3.6, 3.0 to 3.8, 3.0 to 4.0, 3.1 to 3.4, 3.1 to 3.6, 3.1 to 3.8, 3.1 to 4.0, 3.2 to 3.4, 3.2 to 3.6, 3.2 to 3.8, 3.2 to 4.0, 3.3 to 3.4, 3.3 to 3.6, 3.3 to 3.8, 3.3 to 4.0, 3.4 to 3.6, 3.4 to 3.8, or 3.4 to 4.0 at 1 MHz) (IPC-TM-650/2.5.5.3);
n. a dielectric dissipation factor of from 0.001 to 0.03 at 1 MHz (e.g., from 0.001 to 0.01, 0.001 to 0.02, 0.002 to 0.01, 0.002 to 0.02, 0.002 to 0.03, 0.003 to 0.01, 0.003 to 0.02, 0.003 to 0.03, 0.005 to 0.01, 0.005 to 0.02, 0.005 to 0.03, 0.007 to 0.01, 0.007 to 0.02, 0.007 to 0.03, 0.008 to 0.01, 0.008 to 0.02, 0.008 to 0.03, 0.009 to 0.01, 0.009 to 0.02, 0.009 to 0.03, 0.01 to 0.02, or 0.01 to 0.03 at 1 MHz) (IPC-TM-650/2.5.5.3);
o. a flame retardance classification of UL-94 HB;
p. an optical transmittance at 400 nm (% T₄₀₀) of at least 50%, 55%, 60%, 65%, 70%, 75%, 80%, 85%, 90%, 95%, or above (ASTM D1746-15);
q. a yellowness index of not greater than 2.6, 2.5, 2.4, 2.3, 2.2, 2.1, 2.0, 1.9, 1.8, 1.7, 1.6, 1.5, 1.4, or 1.3 (ASTM E313-15e1);
r. an optical transmittance at 550 nm (% T₅₅₀) of at least 60%, 65%, 70%, 75%, 80%, 85%, 90%, 95%, or above;
s. an optical transmittance at 450 nm (% T₄₅₀) of at least 60%, 65%, 70%, 75%, 80%, 85%, 90%, 95%, or above;
t. an optical transmittance at 350 nm (% T₃₅₀) of at least 60%, 65%, 70%, 75%, 80%, 85%, 90%, 95%, or above;
u. an optical transmittance at 300 nm (% T₃₀₀) of at least 60%, 65%, 70%, 75%, 80%, 85%, 90%, 95%, or above;
v. an optical transmittance at 290 nm (% T₂₉₀) of at least 60%, 65%, 70%, 75%, 80%, 85%, 90%, 95%, or above;
w. an optical transmittance at 270 nm (% T₂₇₀) of at least 60%, 65%, 70%, 75%, 80%, 85%, 90%, 95%, or above;
x. an optical transparency at 380 nm of less than 50%, 40%, 35%, 30%, 25%, 20%, 15%, 10%, 8%, 6%, 4%, 2%, or 1% (ASTM D1746-15);
y. an optical transparency at 400 nm of greater than 50%, 60%, 70%, 80%, 82%, 84%, 86%, 88%, 90%, 92%, 94%, 96%, or 98% (ASTM D1746-15); and/or
z. a birefringence (Δn) of −0.005 to +0.005, −0.002 to +0.002, −0.001 to +0.001, or −0.0005 to +0.0005.

In other non-limiting embodiments, the polyimide is optically clear and perceived visually to be devoid of color. In other embodiments, the polyimide has near-zero birefringence that are solution processable.

In some embodiments, the polyimide is end-capped with one or more mono-anhydrides and/or one or more dicarboxylic acids. Examples include trans-1,2-cyclohexanedicarboxylic anhydride, trans-1,2-cyclohexanedicarboxylic acid, cis-1,2-cyclohexanecarboxylic anhydride, cis-1,2-cyclohexanecarboxylic acid, hexahydro-4-methylphthalic anhydride, a mixture of cis and trans bicyclo[2.2.2]octane-2,3-dicarboxylic anhydride, norcantharidin, phthalic anhydride, 4-methylphthalic anhydride, and 5-hydroxy-2-benzofuran-1,3-dione.

In other embodiments, the polyimide is soluble in a polar solvent, which can include pure solvents or mixtures of different solvents. Examples of solvents include N-methyl-2-pyrrolidone (NMP), N,N-dimethylacetamide (DMAc), cyclopentanone, m-cresol, and chloroform.

### Polyimides and Methods of Making

The polyimides herein include those including formula (I), (Ia), or (1), as described herein. Non-limiting polyimides include those having a 1,5-diaminopentyl moiety and a tetravalent organic group, such as any described herein.

Yet other polyimides include those provided by using a 1,5-diaminopentane and an aliphatic dianhydride or tetracarboxylic acid thereof. Non-limiting aliphatic dianhydrides or tetracarboxylic acids thereof include 3,3′,4,4′-bicyclohexyltetracarboxylic acid dianhydride (H-BPDA); 2,3,4,5-tetrahydrofurantetracarboxylic dianhydride; 5-(2,5-dioxotetrahydrofural)-3-methyl-3-cyclohexane-1,2-dicarboxylic dianhydride; butanetetracarboxylic dianhydride; 1,2,3,4-cyclobutanetetracarboxylic dianhydride; 1,3-dimethyl-1,2,3,4-cyclobutanetetracarboxylic dianhydride; 1,2,3,4-cyclobutanetetracarboxylic dianhydride; 2,3,5-tricarboxycyclopentylacetic dianhydride; 3,5,6-tricarboxynorbornane-2-acetic dianhydride; bicyclo[2,2,2]-oct-7-ene-2,3-5,6-tetracarboxylic dianhydride (BODA); 1,2,4,5-cyclohexanetetracarboxylic acid dianhydride (H-PMDA); 3,4-dicarboxy-1,2,3,4-tetrahydro-1-naphthalenesuccinic acid; 4,4′-(hexafluoro isopropylidene)diphthalic anhydride (6-FDA); 2,2′,4,4′-biphenyltetracarboxylic acid dianhydride (BPDA); 2,3,3′,4′-biphenyltetracarboxylic acid dianhydride (aBPDA); 3,3′,4,4′-diphenyl sulphonetetracarboxylic dianhydride; 3,3′,4,4′-diphenylpropane 2,2-tetracarboxylic dianhydride; 2,2-bis(3,4-dicarboxyphenyl)propane dianhydride; 1,4-bis(3,4-dicarboxybenzoyl)benzene dianhydride; 1,3-bis(3,4-dicarboxybenzoyl)benzene dianhydride; pyromellitic dianhydride (PMDA); 4,4′-oxydiphthalic anhydride (OPDA); benzophenone-3,3′,4,4′-tetracarboxylic dianhydride (BTDA); bis(3,4-dicarboxyphenyl) thioether dianhydride; spiro bisindane dietheranhydride; bis-phenol A bisether-4-phthalic dianhydride; 1,4,5,8-naphthalene tetracarboxylic dianhydride; 2,3,6,7-naphthalenetetracarboxylic dianhydride; 3,3′,4,4′-dimethyldiphenylsilanetetracarboxylic dianhydride; 3,3′,4,4′-tetraphenylsilanetetracarboxylic dianhydride; p-phenylene-bis(triphenylphthalic acid)dianhydride; or m-phenylene-bis(triphenylphthalic acid)dianhydride. Yet other examples of aliphatic dianhydrides or tetracarboxylic acids thereof include those of formula (II) or (III), or a salt thereof.

The diamine and/or the aliphatic dianhydride or tetracarboxylic acid thereof can be chemically synthesized. In other embodiments, the diamine and/or the aliphatic dianhydride or tetracarboxylic acid thereof can be obtained by fermentation of one or more engineered microbes selected from the group consisting of gram-positive bacteria (e.g., a bacterium of the genus Corynebacteria or a bacterium of the species glutamicum), gram-negative bacteria, and fungi (e.g., a yeast, such as of the genus Saccharomyces and/or the species cerevisiae).

Methods of combining the diamine and the aliphatic dianhydride or tetracarboxylic acid thereof can include solution-processing. In some embodiments, the method includes solution-processing a polyamic acid polyimide precursor to the polyimide, which is then thermally converted into the polyimide. In other embodiments, the method includes chemical imidization, thermal imidization, or solution imidization.

Methods for producing polyimides are well known to those of skill in the art, and any method may be employed to produce the polyimides described herein, provided the resulting polyimide has at least one of the desirable properties described herein. For example, monomers can be polymerized in high boiling solvents, such as dimethylacetamide (DMAc), N-methyl-2-pyrrolidone (NMP), or m-cresol, which can contain an imidizing agent, such as isoquinoline, which, at elevated temperatures, yields the imidized polymer directly. Alternatively, monomers can be polymerized at low temperatures in polar aprotic solvents, such as DMAc or NMP below 80° C. to yield a polyamic acid that is imidized either chemically or thermally. In chemical imidization, a mixture of an imidizing catalyst, such as a tertiary amine, and a dehydrating agent such as an aliphatic anhydride are added to the polymerization solution. Typical imidizing catalysts are triethylamine, a pyridine or a pyridine derivative, or isoquinoline. A typical dehydrating agent is acetic anhydride. Imidization can also be carried out by the combination of chemical and thermal methods.

After imidization, the polyimides can be isolated by precipitation into a non-solvent, such as an alcohol. Typical non-solvents used for this purpose are methanol or ethanol. After polymer isolation and drying, a film casting solution can be prepared by dissolving the polymer into a polar solvent, such as DMAc, NMP, cyclopentone, or chloroform.

### Tetravalent Organic Groups

The polyimide herein includes a tetravalent organic group, which in turn is attached to the 1,5-aminopentane moiety to form imide bonds. In particular embodiments, the tetravalent organic group include one or more cyclic aliphatic groups. Non-limiting cyclic aliphatic groups can include one or more optionally substituted trivalent or tetravalent cycloalkylene groups.

Non-limiting tetravalent organic groups (e.g., for L¹) include the following:

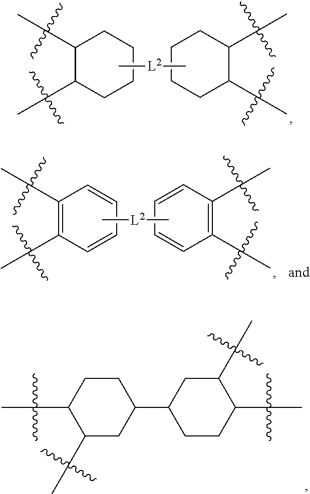

in which L² is a covalent bond, oxy, an optionally substituted alkylene, an optionally substituted heteroalkylene, an ester bond, carbonyl, thio, sulfonyl, imino, or an amide bond.

In particular embodiments, L² is a covalent bond. In other embodiments, L² is an optionally substituted alkylene (e.g., —CLₐL_{b}- or —(CLₐL_{b})₂- in which each of Lₐ and L_{b} is, independently, H, halo, alkyl, or haloalkyl).

Other non-limiting tetravalent organic groups include >Ar<, >Cy<, >Ar—Ar<, >Cy-Cy<, >Ar—O—Ar<, >Cy-O-Cy<, >Ar—C(O)—Ar<, >Cy-C(O)-Cy<, >Ar—C(L^{a}L_{b}-Ar<, >Cy-CL^{a}L^{b}-Cy<, >Ar—C(L^{a})(L^{b})C(L^{a})(L^{b})-Ar<, or >Cy-C(L^{a})(L^{b})C(L^{a})(L^{b})-Cy<, in which Ar is an optionally substituted trivalent or tetravalent arylene (e.g., any described herein, such as optionally substituted trivalent or tetravalent phenyl group), Cy is an optionally substituted trivalent or tetravalent cycloalkylene (e.g., any described herein, such as optionally substituted trivalent or tetravalent cyclohexyl group), and each of L^{a} and L_{b} is, independently, H, halo, alkyl, or haloalkyl.

Yet other non-limiting tetravalent organic groups include tetrahydrofuran-2,3,4,5-tetrayl, cyclohexane-1,2,4,5-tetrayl, 3,6-dimethylcyclohexane-1,2,4,5-tetrayl, dicyclohexane-3,3′,4,4′-tetrayl, benzene-1,2,4,5-tetrayl, benzophenone-3,3′,4,4′-tetrayl, 2,2-diphenylhexafluoropropane-3′,3″,4′,4″-tetrayl, diphenylether-3,3′,4,4′-tetrayl, diphenylsulfide-3,3′,4,4′-tetrayl, diphenylsulphone-3,3′,4,4′-tetrayl, naphthalene-2,3,6,7-tetrayl, 4,4′-(hexafluoroisopropylidene) dibenzene-1,1′,2,2′-tetrayl, or dibenzene-2,3,3′,4′-tetrayl,

### Uses

The polyimides and articles thereof can be employed in any useful manner. Without wishing to be limited by mechanism, the polyimides herein provide a relatively high modulus but with enhanced stretchiness/elongation at break, as compared to commercial polyimides. Combined with a reasonable Tg that can survive soldering, the polyimides herein could lead to other technical and engineering applications.

In particular embodiments, the polyimide or an article thereof includes use in flexible electronics, consumer electronic devices, displays (e.g., electronic displays, liquid crystal displays, electroluminescent displays, and electronic papers), microelectronic components, biosensors, solar cells, radiotelescopes, flexible large scale antennas, conformal antennas, wearables (e.g., for individual monitoring), anticounterfeit applications, human-machine interfacing, photonic sensing, soft embedded power, soft robotics, aerial systems (e.g., unmanned aerial systems), optics, complex 3D structures, small-scale satellites, deployable structures, organic light-emitting diodes (OLED), and active-matrix liquid-crystal (AM-LCD) displays. In other embodiments, the article is coated with the polyimide, and the article is an article with electronic, aerospace, automotive, architectural, industrial, or civil engineering application.

In some embodiments, the polyimides described herein can be used in electronics applications, such as, but not limited to microelectronic components or electronic displays. For example, the polyimide can be used as a transparent base material in the display. In various embodiments, the polyimides can be used in waveguides, organic light emitting diodes, electronic paper, liquid crystal displays, electroluminescent display, thin film transistors, flexible electronics, wearable electronics, and as a dielectric material. In certain embodiments, the polyimides described herein can be used in solar cells, e.g., where the polyimide is a transparent substrate in the solar cell.

Other non-limiting uses include applications as a substrate, a coating, a base material, a circuit, an adhesive, a film, a fiber, as well as flexible forms thereof and/or UV-cured forms thereof. In other embodiments, the use includes a transparent base material or a transparent substrate. In particular embodiments, the article is produced by a means selected from the group consisting of solution cast lines, ink jetting, dip coating, spraying, spin coating, and electrospinning. In other embodiments, the article is produced by means selected from the group consisting of blow molding, extrusion, pultrusion, and injection molding. In yet other embodiments, the polyimide is melt-processed into a material selected from the group consisting of a film, a fiber, a compounded masterbatch, and a part.

In particular embodiments, the polyimides are used as, or incorporated into, a film that has a thickness between 10 nm and 1 cm (inclusive). In various embodiments, the film thickness is on the order of 10, 50, 100, 200, 300, 400, 500 600, 700, 800, or 900 nm, or 1, 10, 50, 100, 200, 300, 400, 500, 600, 700, 800, or 900 mm, or 1 cm. In some embodiments, the film thickness falls within a range bounded by any of these values, e.g., 50 nm to 900 mm, 200 nm to 700 mm, 500 nm to 500 mm (including the endpoints).

In other embodiments, the polyimide can be used with one or more additives. Non-limiting additives include one or more of the following: a filler; a particle (e.g., a nanoparticle, microparticle, glass bead, silica nanoparticle); a stabilizer (e.g., optical stabilizers and/or thermal stabilizers); an anti-aging agent (e.g., an antioxidant); a heat stabilizer (e.g., organo-tin compounds); a UV stabilizer (e.g., benzophenones or salicylates); or combinations thereof.

### EXAMPLES

### Example 1: Synthesis of HBPDA-Cadaverine Polyimide (500 g)

M-cresol was freshly distilled to remove color and moisture from the polymerization solvent. Into a three neck 1 L flask equipped with a nitrogen inlet, a short-path distillation head with a receiving flask and nitrogen outlet, and a mechanical stirrer, cadaverine (152.77 g, 1.4951 mol) and m-cresol (1000 mL) were placed under nitrogen atmosphere for five minutes. Isoquinoline (31 mL) was then added. 3,3′,4,4′-Bicyclohexyltetracarboxylic acid dianhydride (HBPDA, 457.97 g, 1.4951 mol) was then added all at once to the flask and washed in with 1228 mL of m-cresol. The mixture was stirred at room temperature for 30 minutes, and then slowly ramped to 130° C. over a period of 6 hours. After 24 hours, the reaction was ramped further to 170° C. over a period of 8 hours and left after 170° C. overnight. After 48 hours of reaction time, the solution was cooled to 60° C., and the IV checked.

The polymer was then precipitated into methanol. When poured quickly into methanol, a large gelatinous mass was obtained that is very sticky. Blending causes the material to stick to the blender and is difficult to remove. The mass was cut into pieces, and methanol soaks continued until the pieces became hard. Once hard, the pieces were blended in a commercial blender into small pellets. The pellets were isolated by vacuum filtration, and then placed back into methanol. This filter/soak cycle was conducted five times to efficiently remove the m-cresol from the polymer. The polymer was then dried in a vacuum oven under reduced pressure initially at 60° C. first as the polymer would soften with residual methanol, and then heated to 140° C. for 24 hours. Yield=530.4 g, 95.3%; IV=0.59 dL/g.

The polymer can be provided within a solution and then solution cast into films for characterization. Optical, thermal, and mechanical properties of the HBPDA-cadaverine polyimide are provided in Table 1. Provided properties include glass transition temperature (Tg), intrinsic viscosity (IV), refractive index (n), birefringence (Δn), transmittance at 400 nm (% T₄₀₀), modulus (E), tensile strength or break stress (a), elongation at break or break strain (s), and decomposition temperature (Td).

TABLE 1
Optical, thermal, and mechanical properties of HBPDA-cadaverine polyimide

| Tg [° C.] | IV [dL/g] | n | Δn | % T₄₀₀ | E [GPa] | σ [MPa] | ε [%] | Td [° C.] |
|---|---|---|---|---|---|---|---|---|
| 145 | 0.59 | 1.5489 | −0.0002 | 78 | 2.68 | 67 | 4.1 | 413 |

### Example 2: Characterization of Stretched Polymer Films

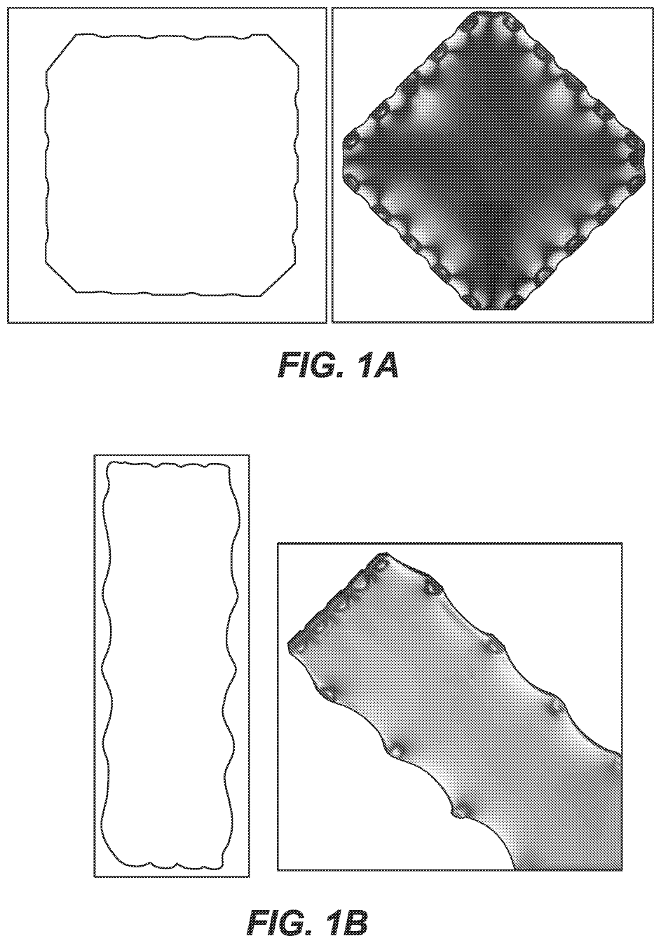

Films were treated to uniaxial or biaxial stretching in the presence of heat. First, polyimide solutions were prepared by employing the polyimide in a polar solvent. Then, polyimide solutions were employed to cast films on a substrate, which was then dried. For stretching, films were heated near the Tg and then stretched in one direction (e.g., uniaxial stretching, such as in a longitudinal direction) or in two directions (e.g., biaxial stretching, such as in both the longitudinal and transverse directions). FIG. 1A shows a film before stretching, and FIG. 1B shows a film after uniaxial stretching along the longitudinal axis (stretch ratio of 3.0×1.0, in which the film is stretched to three times the original length along the longitudinal axis and not stretched along the transverse axis) at a stretch temperature of 140° C. and stretch rate of 1%/s.

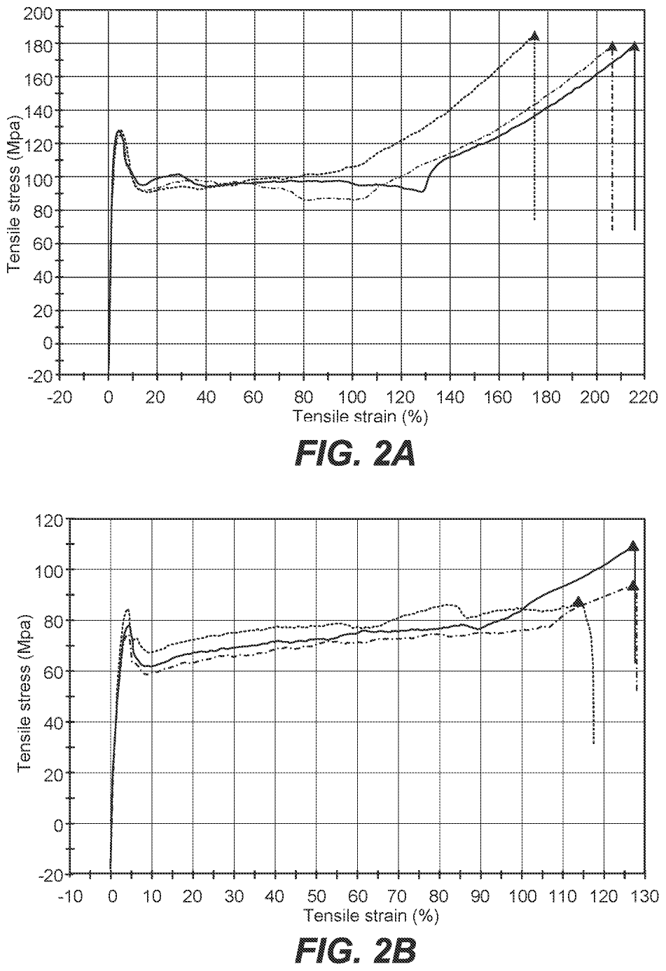

Without wishing to be limited by mechanism, when stretched near the Tg, this material undergoes a structural change causing it to have extremely high elongation at break after return to room temperature. To the best of our knowledge, the HBPDA-cadaverine polymer is the stretchiest polyimide found so far in the literature. In particular, this polyimide exhibits increased elongation at break after stretching, with comparatively little change in Young's modulus. FIG. 2A-2B provides stress-strain curves for this polyimide, which indicate clear yield points and enhanced plastic deformation.

Table 2 provides mechanical properties for HBPDA-cadaverine films, which have been stretched at different stretch ratios (a ratio of the stretch distance along a longitudinal axis versus along a transverse axis) and at two different stretch temperatures (130° C. or 140° C., which is near the Tg of 145° C. for this polyimide).

TABLE 2
Mechanical properties of stretched polymer films

| | | Stretch | | Yield | Break | Total | | | Break |
|---|---|---|---|---|---|---|---|---|---|
| Sample | Stretch | temp. | Modulus | stress | strain | strain | Strain | Hardening | stress |
| No. | ratio | [° C.] | [GPa] | [MPa] | [%] | [%] | hardening | strain [%] | [MPa] |
| 1 (as cast) | — | — | 2.52 | — | 4.7 | 4.7 | — | — | 74 |
| 2 | 1.5 × 1.0 | 130 | 2.31 | 62 | 35 | 203 | No | — | 46 |
| 3 | 2.0 × 1.0 | 130 | 2.35 | 63 | 171 | 542 | Yes | 125 | 81 |
| 4 | 2.5 × 1.0 | 130 | 2.20 | 52 | 137 | 593 | Yes | 80 | 103 |
| 5 | 3.0 × 1.0 | 130 | 2.26 | 54 | 128 | 684 | Yes | 107 | 65 |
| 6 | 3.0 × 1.0 | 140 | 2.30 | 57 | 215 | 945 | Yes | 130 | 80 |
| 7 | 1.5 × 1.5 | 130 | 1.95 | 52 | 35 | 203 | No | — | — |
| 8 | 1.7 × 1.3 | 130 | 2.20 | 50 | 159 | 440 | Yes | 135 | 56 |

Stretched and as-cast films of HBPDA-cadaverine exhibited beneficial optical properties. As seen in Table 3, stretched films exhibited orientation, yielding C-type materials with reversed dispersion like cyclic olefin polymers (COPs) and cellulosics.

TABLE 3
Optical properties of stretched polymer films

| | | Stretch | | | | | | |
|---|---|---|---|---|---|---|---|---|
| | Stretch | temp. | Re550 | Re450/ | Re650/ | Rth550 | Rth450/ | Rth650/ |
| Sample No. | ratio | [° C.] | [nm] | Re550 | Re550 | [nm] | Rth550 | Rth550 |
| 1 (as cast) | — | — | 0.4 | 1.050 | 0.953 | −0.6 | 0.922 | 1.361 |
| 2 | 1.5 × 1.0 | 130 | 34.9 | 0.986 | 1.006 | −35.5 | 1.013 | 0.984 |
| 3 | 2.0 × 1.0 | 130 | 47.7 | 0.987 | 1.005 | −43.5 | 1.004 | 0.993 |
| 4 | 2.5 × 1.0 | 130 | 58.7 | 0.988 | 1.006 | −45.6 | 1.005 | 0.992 |
| 5 | 3.0 × 1.0 | 130 | 48.4 | 0.988 | 1.005 | −43.6 | 0.999 | 0.997 |
| 6 | 3.0 × 1.0 | 140 | 27.1 | 0.989 | 1.005 | −18.3 | 0.995 | 0.998 |
| 7 | 1.5 × 1.5 | 130 | 7.8 | 0.990 | 1.004 | −49.1 | 0.993 | 1.003 |
| 8 | 1.7 × 1.3 | 130 | 24.4 | 0.989 | 1.005 | −36.9 | 0.994 | 1.000 |

Electrical and flammability properties were also characterized. For Table 4, polymer solutions were synthesized, filtered through 0.45 μm PTFE paper, cast onto a substrate with a target thickness of 15 m, and then dried prior to testing.

TABLE 4
Electrical properties

| | Dielectric | Dielectric | Breakdown |
|---|---|---|---|
| | constant | dissipation factor | voltage |
| Material | (@ 1000 Hz) | (@ 1000 Hz) | [kV/mm] |
| HBPDA- | 3.45 | 0.011 | 455 |
| cadaverine | | | |
| 6FDA-cadaverine | 3.10 | 0.007 | 423 |
| Apical | 3.9 | 0.0035 | 236 (min) |
| Kapton | 3.4 | 0.0020 | 303 |
| Mylar (PET) | 3.25 | 0.005 | 350 |
| Teonex (PEN) | 3.05 | 0.003 | 450 |

For Table 5, polymer solutions were synthesized, filtered, cast onto a substrate with a target thickness of 50 μm, and then dried prior to testing. The films exhibited flammability resistance (classification UL-94-HB) employing the UL-94 standard (flame height: 20 mm, flame application: 30 seconds; specimen size: 125×13×0.05 mm; 3 specimens for each material).

TABLE 5
Flammability properties

| Material | Burn rate [mm/min] | UL94 standard |
|---|---|---|
| HBPDA-cadaverine | 1125 | ≤75 mm |
| 6FDA-cadaverine | 1500 | ≤75 mm |

### OTHER EMBODIMENTS

All publications, patents, and patent applications mentioned in this specification are incorporated herein by reference to the same extent as if each independent publication or patent application was specifically and individually indicated to be incorporated by reference.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the claims.

Other embodiments are within the claims.

1. A stretched polymeric article comprising a polyimide that comprises the formula (I): 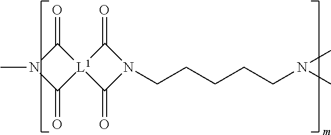
or a salt thereof, wherein:
L¹ is a tetravalent organic group;
m is an integer from 1 to 10,000, and
wherein the article is characterized by an increased break strain after stretching the article, as compared to an initial break strain before stretching.

2. The article of claim 1, wherein the increased break strain is about 5 times greater than the initial break strain.

3. (canceled)

4. (canceled)

5. The article of claim 1, wherein the article is a heat-stretched polymeric article 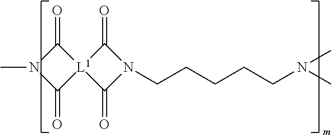
and
wherein the article is characterized by a break strain greater than about 30% or more.

6. The article of claim 5, wherein the heat-stretched polymeric article is heat stretched at a temperature within about ±50% of a glass transition temperature (T_{g}) of the polyimide.

7. (canceled)

8. The article of claim 1, wherein the polyimide and/or the article comprises one or more of the following properties:
a. an in-plane retardation at wavelength of 550 nm (Re550) is 5 nm or more;
b. a ratio of in-plane retardation at wavelengths of 450 nm and 550 nm (Re450/Re550) is 1.2 or less;
c. a ratio of in-plane retardation at wavelengths of 650 nm and 550 nm (Re650/Re550) is 0.9 or more;
d. a retardation in a thickness direction at wavelength of 550 nm (Rth550) is −0.5 nm or less;
e. a ratio of retardation in a thickness direction at wavelengths of 450 nm and 550 nm (Rth450/Rth550) is 0.9 or more;
f. a ratio of retardation in a thickness direction at wavelengths of 650 nm and 550 nm (Rth650/Rth550) is 1.3 or less;
g. a glass transition temperature of from about 100° C. to about 400° C. (ASTM D3418-15, D4065, D4440, or D5279);
h. a Young's modulus of from about 0.5 GPa to about 10 GPa (ASTM D638 or ISO 527-1/-2);
i. a yield stress of from about 10 MPa to about 100 MPa (ASTM D638 or ISO 527-1/-2);
j. a break strain of from about 7% to about 250% (ASTM D638 or ISO 527-1/-2);
k. a total strain of from about 7% to about 1000% (ASTM D638 or ISO 527-1/-2);
l. a break stress of from about 80 MPa to about 200 MPa (ASTM D638 or ISO 527-1/-2);
m. a dielectric constant of from about 2.8 to about 4.0 at 1 MHz (IPC-TM-650/2.5.5.3);
n. a dielectric dissipation factor of from about 0.001 to about 0.03 at 1 MHz (IPC-TM-650/2.5.5.3);
o. a flame retardance classification of UL-94 HB;
p. an optical transmittance of at least 60 percent at 400 nm and above; and/or
q. a yellowness index of not greater than about 2.5 (ASTM E313-15el).

9. The article of claim 1, wherein L¹ comprises a cyclic aliphatic group.

10. The article of claim 1, wherein the polyimide comprises the formula Ia): 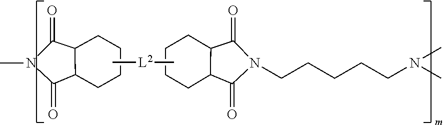
or a salt thereof, wherein:
L² is a covalent bond, oxy, an optionally substituted alkylene, or an optionally substituted heteroalkylene.

11. The article of claim 1, wherein the polyimide comprises the formula (1): 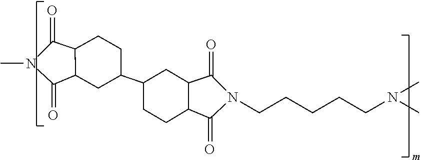
or a salt thereof.

12. (canceled)

13. The article of claim 1, wherein the article comprises a flexible circuit, a flexible component, a flexible connector, a flexible substrate, a flexible coating, a flexible sensor, a conformal coating, a conformal substrate, a wearable electronic device, a conformal component, a soft electronic component, or a conformal antenna, wherein a flexible electronic component configured to be heat treated, soldered, or welded, wherein the article comprises a tubing, a film, a substrate, a fiber, a coating, a sheet, a molded article, a housing, a connector, a frame, or an extruded article or wherein the article comprises a tubing, a film, a substrate, a fiber, a coating, a sheet, a molded article, a housing, a connector, a frame, or an extruded article.

14. (canceled)

15. (canceled)

16. The article of claim 1, wherein the article is the film or the substrate with a thickness between 10 nanometers and 1 cm.

17. The article of claim 12, wherein the article is coated with the polyimide.

18. (canceled)

19. (canceled)

20. A method of making a polymeric article, the method comprising: combining 1,5-diaminopentane and an aliphatic dianhydride or tetracarboxylic acid thereof, thereby providing a polyimide; forming the polymeric article comprising the polyimide; and stretching the polyimide in the presence of heat to provide a heat-stretched polymeric article, wherein the article is characterized by: an increased break strain after stretching the article, as compared to an initial break strain before stretching; and/or a break strain greater than about 30% or more.

21. The method of claim 20, wherein the aliphatic dianhydride or tetracarboxylic acid thereof is 3,3′,4,4′-bicyclohexyltetracarboxylic acid dianhydride (HBPDA), 2,2,3,3-bicyclohexyltetracarboxyhc dianhydnde (3,3-HBPDA), 2,3,3,4-bicyclohexyltetracarboxylic dianhydride (3,4′-HBPDA), or a stereoisomer thereof.

22. The method of claim 20, said combining comprises 1,5-diaminopentane and the aliphatic dianhydride or tetracarboxylic acid thereof at a molar ratio of about 1:1.

23. The method of claim 20, wherein the polymeric article or the polyimide comprises a tubing, a film, a substrate, a fiber, a coating, a sheet, a molded article, a housing, a connector, a frame, or an extruded article.

24. The method of claim 20, wherein the polyimide comprises the formula (I): 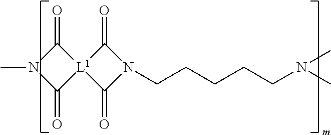
or a salt thereof, wherein:
L¹ is a tetravalent organic group; and
m is an integer from 1 to 10,000.

25. The method of claim 24, wherein the polyimide comprises the formula Ia): 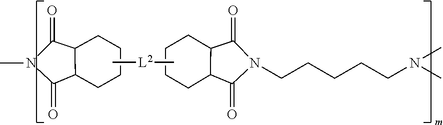
or a salt thereof, wherein:
L² is a covalent bond, oxy, an optionally substituted alkylene, or an optionally substituted heteroalkylene.

26. The method of claim 24, wherein the polyimide comprises the formula (1): 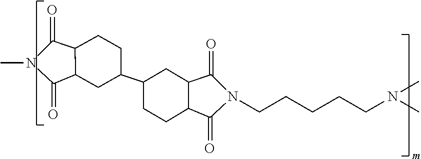
m or a salt thereof.

27. The method of claim 20, wherein said stretching comprises a temperature within about ±50% of a glass transition temperature (T_{g}) of the polyimide.

28. The method of claim 20, wherein said stretching comprises uniaxial or biaxial stretching, or wherein said uniaxial stretching comprises a stretch ratio of about 1.2 by 1 to 4 by 1.

29. (canceled)
